(19) United States
(12) Patent Application Publication
(10) Pub. No.: US 2005/0231933 A1
(43) Pub. Date: Oct. 20, 2005

(54) Illuminated keyboard with illuminated patterns displayed on top surface of keyboard

(75) Inventor: Cheng Hua Chuang, Taipei (TW)

Correspondence Address: G .LINK Co.,LTD, 3550 Bell Road, MINOOKA, IL, 60447, US

(73) Assignee: BEHAVIOR TECH COMPUTER CORP.

(21) Appl. No.: 11/049,170

(22) Filed: Feb. 3, 2005

(30) Foreign Application Priority Data
Apr. 19, 2004 (TW) 093206036

(51) Int. Cl. G01D 11/28

(52) U.S. Cl. 362/23

(57) ABSTRACT

An illuminated keyboard with illuminated of figured pattern on top surface of the keyboard includes: a top cover, a bottom cover, a plurality of keys and an electroluminescent board. The top cover accommodates the keys and is combined with the bottom cover. The electroluminescent board is installed between the top cover and the bottom cover. The electroluminescent board includes at least one figured pattern to be displayed on a top surface of the keyboard on the top cover when the electroluminescent board is electrified to give light.

### FIELD OF THE INVENTION

The present invention relates to an illuminated keyboard, particularly a user-friendly illuminated keyboard with illuminated patterns displayed on the top surface of the keyboard.

### BACKGROUND OF THE INVENTION

The conventional illuminated keyboard using an electroluminescent light as a light source is mainly for the purpose of continued operation even in a darkened environment. An electroluminescent board is installed inside such conventional illuminated keyboard. When power is supplied, the electroluminescent board is illuminated to emit a light onto the keyboard. But the main purpose of the electroluminescent board installed in that illuminated keyboard is to enable a continued illuminated light in a darkened environment. To the user of that illuminated keyboard, such a device provides only the feeling of a cold-hearted device.

In view of the above shortcoming in the conventional illuminated keyboard, the present inventor has come up with a keyboard with an illuminated effect on top of the keyboard, providing a user-friendly feeling by displaying figured patterns on top of the keyboard using the light projected from the electroluminescent board, in addition to its regular function of providing an illuminated light in a darkened environment.

### SUMMARY OF THE INVENTION

It is the first objective of this invention to provide an illuminated keyboard with illuminated patterns displayed on top of the keyboard.

It is a second objective of this invention to provide an illuminated keyboard with contrasted illuminated patterns displayed on top of the keyboard.

It is a third objective of this invention to provide an illuminated keyboard that, in addition to enabling continued operation even in a darkened environment, it has enhanced user-friendliness to the keyboard, by displaying figured patterns on top of the keyboard.

To achieve the above objectives, the present invention provides an illuminated keyboard with illuminated patterns on top of the keyboard includes a plurality of keys, a top cover accommodating the keys, a bottom cover that is combined with the top cover, and an electroluminescent board installed between the top cover and the bottom cover; wherein the electroluminescent board includes figured patterns that can be illuminated and displayed on top of the keyboard.

### BRIEF DESCRIPTION OF THE DRAWINGS

The above objects and advantages of the present invention will become more apparent with reference to the appended drawings wherein:

FIG. 1 is an exploded view of the present invention of the keyboard with illuminated patterns displayed on top of the keyboard;

FIG. 2 is a first embodiment view of the electroluminescent board in the invention;

FIG. 3 is a second embodiment view of the electroluminescent board in the invention;

FIG. 4 is a third embodiment view of the electroluminescent board in the invention; and

FIG. 5 is a fourth embodiment view of the electroluminescent board in the invention.

### DETAILED DESCRIPTION OF THE INVENTION

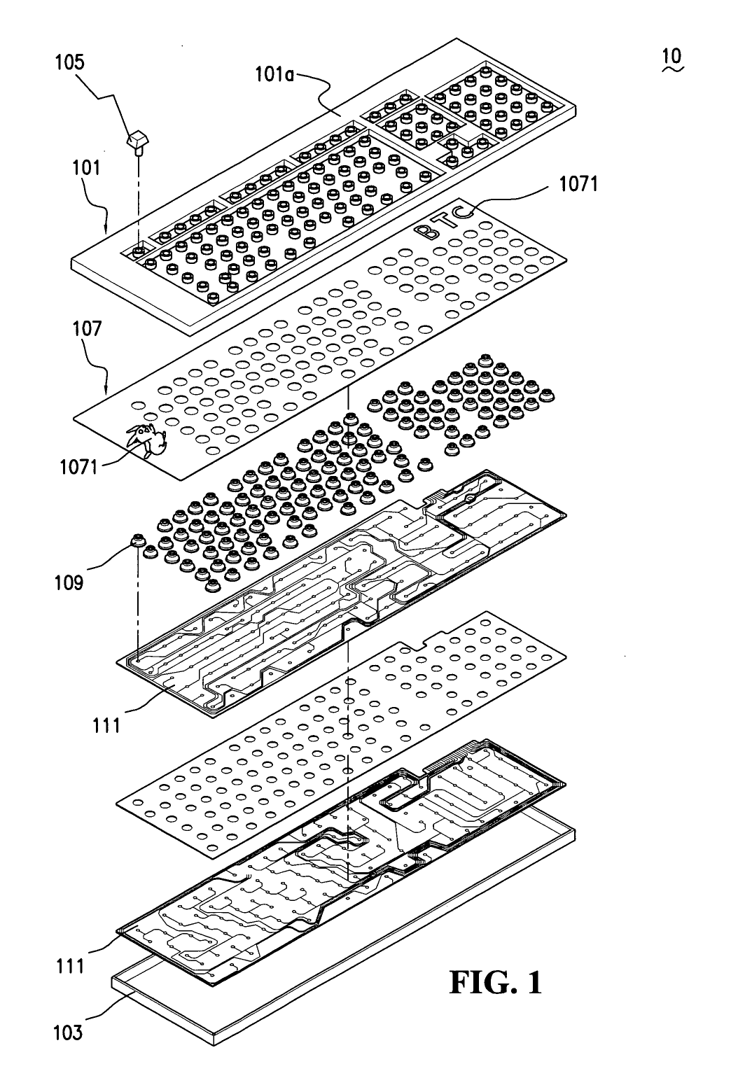

FIG. 1 shows an exploded view of the present invention of illuminated keyboard with figured patterns displayed on top of the keyboard. The present invention of illuminated keyboard 10 includes at least a top cover 101, a bottom cover 103, a plurality of keys 105 and an electroluminescent board 107. In assembling the keyboard 10, the final step is to combine the top cover 101 with the bottom cover 103 as one unit. The space formed by the top cover 101 and the bottom cover 103 is used to accommodate the electroluminescent board 107 and related components, including a plurality of flexible members 109 and membrane circuit boards 111. To enable penetration of the electroluminescent light emitting from the electroluminescent board 107 through the top surface of keyboard 101a, the top cover 101 is preferably made of transparent materials. The keys 105 are installed on the top cover 101. The keys 105 of the invention are preferably see-through keys, thereby to enable penetration of electroluminescent light emitted by the electroluminescent board 107. The top surface of keyboard 101a covers an area including the area occupied by the keys 105, as well as the other area of the top cover 101 not occupied by the keys 105. Importantly, the main purpose of the top surface of keyboard 101a is to display a visual effect created by the electroluminescent light emitted from the electroluminescent board 107.

The electroluminescent board 107 is installed between the top cover 101 and the bottom cover 103; for instance, the electroluminescent board 107 is installed on a bottom side of the top cover 101. The most important characteristic of the electroluminescent board 107 of the invention is its inclusion of at least one figured pattern 1071. The physical figure of the figured pattern 1071 is optionally one of the following: a cartoon figure, a series of text and digits, or a picture pattern.

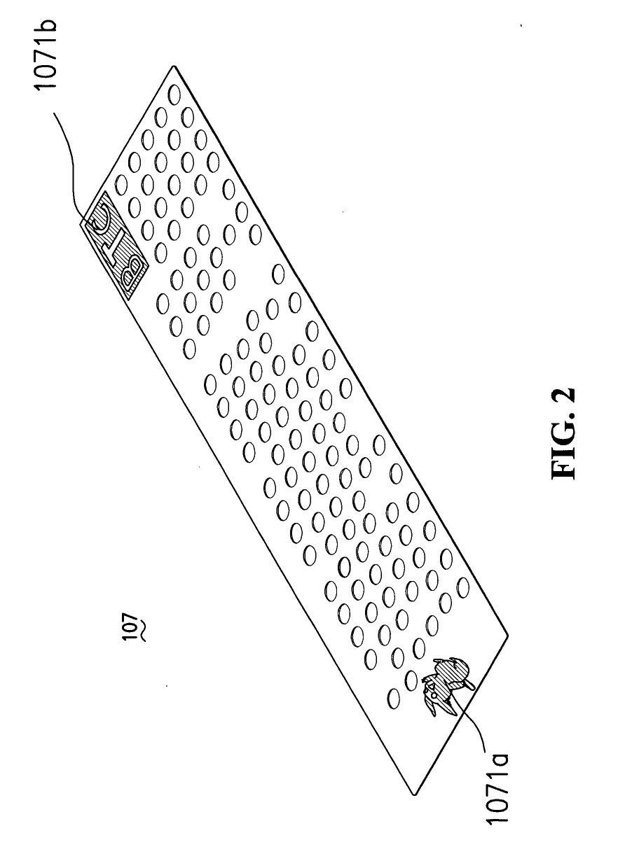

FIG. 2 shows a first embodiment view of the electroluminescent board in the invention. On the electroluminescent board 107 shown in FIG. 2, the figured pattern 1071a (in diagonal lines) is coated with electroluminescent material, to enable display of illuminated patterns when they are electrified. When the light of the figured pattern 1071a penetrates the top surface of keyboard 101a, the figured pattern 1071a is lit and displayed on the top surface of keyboard 101a. The figured pattern 1071b consists of a series of letters “BTC”. The alphabets “BTC” itself could not be electrified to give light. The remaining area (diagonal lines) surrounding the figured pattern 1071b, such as a rectangular zone but excluding the letters “BTC”, is coated with electroluminescent material; when this surrounding area is electrified to give light, a contrasted effect of illuminated showing the figured pattern 1071b is then displayed on the top surface of keyboard 101a.

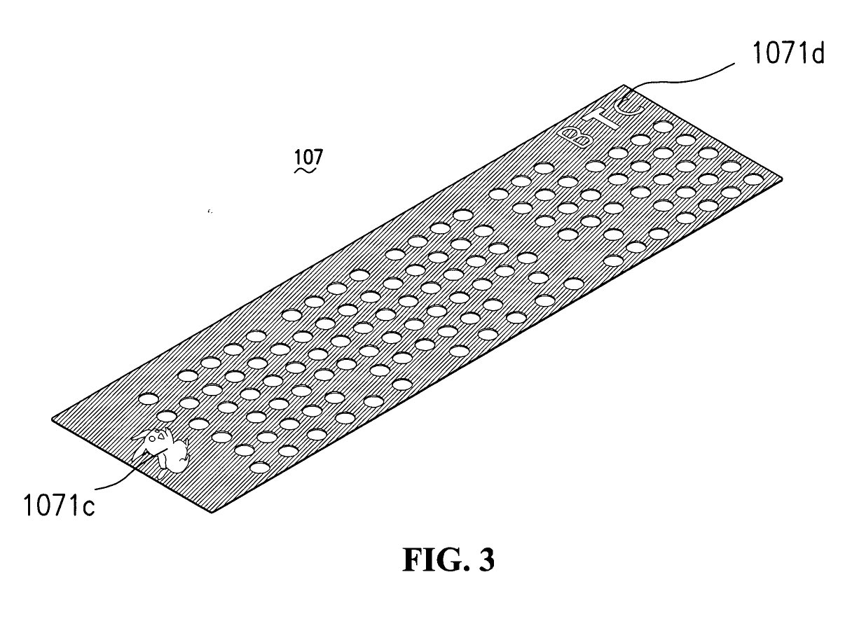

FIG. 3 shows a second embodiment view of the electroluminescent board in the invention. On the electroluminescent board 107 shown in FIG. 3, the figured patterns 1071c, 1071d are not capable of being electrified to give light, while the other area on the electroluminescent board 107 (diagonal lines) is coated with electroluminescent material. When the electroluminescent board 107 is electrified to give light, most of the area on the top surface of keyboard 101a on the top cover 101 displays an illuminated effect, thereby displaying the contrasted effect of the figured patterns 1071c, 1071d.

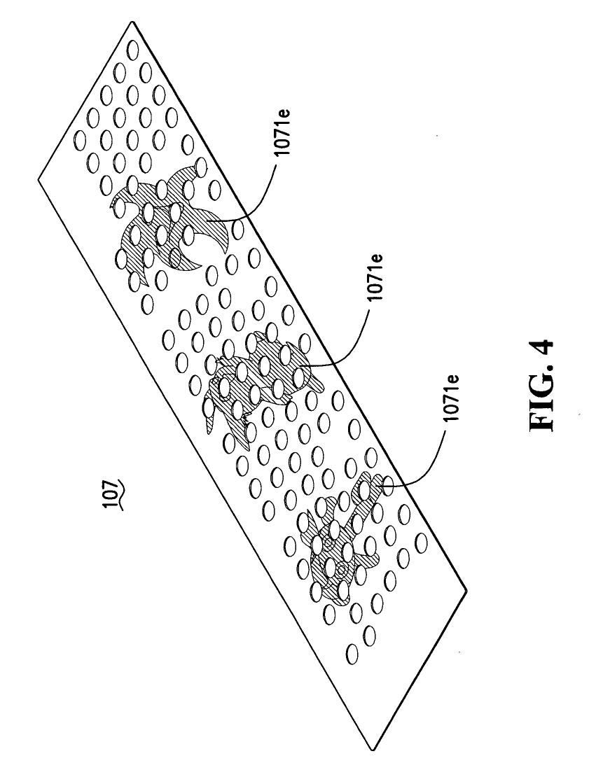

FIG. 4 shows a third embodiment view of the electroluminescent board in the invention. On the electroluminescent board 107 shown in FIG. 4, the figured patterns 1071e (diagonal lines) are coated with electroluminescent material, directly on the electroluminescent board 107. Coating of the material on the figured patterns 1071e are positioned on the surface occupied by these keys 105. When the figured patterns 1071e on the electroluminescent board 107 are electrified to give light, the top surface of keyboard 101a where the keys 105 are located will display an illuminated effect of the figured patterns 1071e.

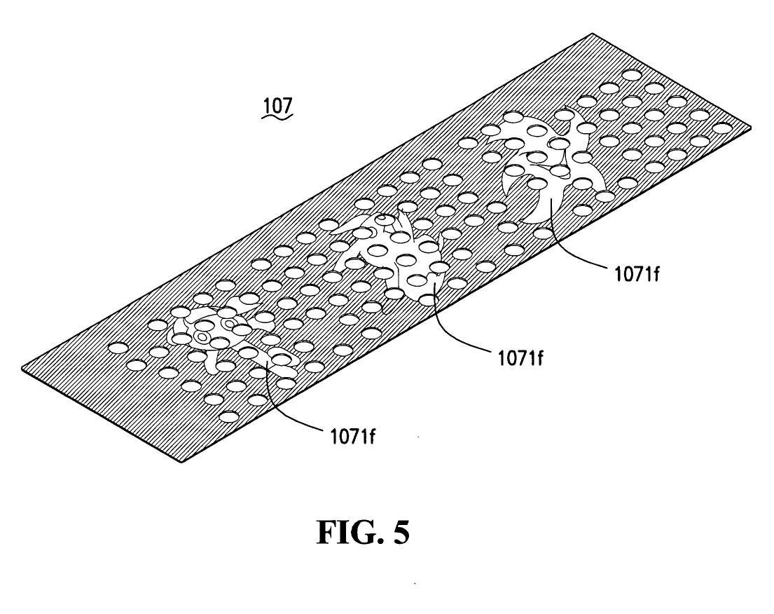

FIG. 5 shows a fourth embodiment view of the electroluminescent board in the invention. On the electroluminescent board 107 shown in FIG. 5, the figured patterns 1071f themselves are not capable of being electrified to give light, but the figures are formed on the electroluminescent board 107. Except the figured patterns 1071f, other area (diagonal lines) of the electroluminescent board 107 is coated with electroluminescent material. The area marked with diagonal lines corresponds to the area occupied by the keys 105. When the electroluminescent board 107 is electrified to give light, the area marked with diagonal lines displays an illuminated effect, thereby contrasting the display of the figured patterns 1071f, where the contrasted display of the figured patterns 1071f is visible on these keys 105.

Using the characteristic of the electroluminescent board 107 that is capable of being electrified to give light, the invention of keyboard 10 can be operated even in a darkened environment, by displaying an illuminated effect of the figured patterns on the top surface of the keyboard, providing the user of keyboard with a feeling of variable illuminated on the keyboard, as well as another kind of visual enjoyment.

It is to be understood that variations or modifications may be made on the present invention by whoever skilled in the art without departing from the spirit and intent of the invention, and that all variations and modifications so made should be included in the following claim.

1. A type of illuminated keyboard with illuminated of figured pattern on top of the keyboard, comprising:
a plurality of keys;
a top cover accommodating the keys;
a bottom cover combined with the top cover; and
an electroluminescent board, installed between the top cover and the bottom cover,
wherein the electroluminescent board includes at least one figured pattern to be displayed on a top surface of the keyboard on the top cover when the electroluminescent board is electrified to give light.

2. The illuminated keyboard with illuminated of figured pattern on top of the keyboard as claimed in claim 1, wherein the figured pattern is capable of being electrified to give light.

3. The illuminated keyboard with illuminated of the figured pattern on top of the keyboard as claimed in claim 1, wherein the figured pattern is not capable of being electrified to give light, while an area surrounding the figured pattern is capable of being electrified to give light.

4. The illuminated keyboard with illuminated of the figured pattern on top of the keyboard as claimed in claim 1, wherein the figured pattern is a cartoon figure.

5. The illuminated keyboard with illuminated of figured pattern on top of the keyboard as claimed in claim 1, wherein the figured pattern is a series of digital signs.

6. The illuminated keyboard with illuminated of figured pattern on top of the keyboard as claimed in claim 1, wherein the key is a see-through key.

7. The illuminated keyboard with illuminated of figured pattern on top of the keyboard as claimed in claim 1, wherein the top surface of the keyboard on the top cover is a see-through top surface.

8. The illuminated keyboard with illuminated of figured pattern on top of the keyboard as claimed in claim 1, wherein the top cover is a see-through top cover.

9. A illuminated keyboard with illuminated of figured pattern on top of the keyboard, comprising: a plurality of keys, a top cover accommodating the keys, a bottom cover that is combined with the top cover, and an electroluminescent board installed between the top cover and the bottom cover; characterized in that: the electroluminescent board includes at least one figured pattern to be displayed on a top surface of the keyboard on the top cover when the electroluminescent board is electrified to give light.

10. The illuminated keyboard with illuminated of figured pattern on top of the keyboard as claimed in claim 9, wherein the figured pattern is capable of being electrified to give light.

11. The illuminated keyboard with illuminated of the figured pattern on top of the keyboard as claimed in claim 9, wherein the figured pattern is not capable of being electrified to give light, while an area surrounding the figured pattern is capable of being electrified to give light.

12. The illuminated keyboard with illuminated of the figured pattern on top of the keyboard as claimed in claim 9, wherein the figured pattern is a cartoon figure.

13. The illuminated keyboard with illuminated of figured pattern on top of the keyboard as claimed in claim 9, wherein the figured pattern is a series of digital signs.

14. The illuminated keyboard with illuminated of figured pattern on top of the keyboard as claimed in claim 9, wherein the key is a see-through key.

15. The illuminated keyboard with illuminated of figured pattern on top of the keyboard as claimed in claim 9, wherein the top surface of the keyboard on the top cover is a see-through top surface.

16. The illuminated keyboard with illuminated of figured pattern on top of the keyboard as claimed in claim 9, wherein the top cover is a see-through top cover.
